(19) United States
(12) Patent Application Publication
(10) Pub. No.: US 2020/0184435 A1
(43) Pub. Date: Jun. 11, 2020

(54) INTERCONNECTED RESOURCE DISTRIBUTION AND RETENTION NETWORK

(71) Applicant: BANK OF AMERICA CORPORATION, Charlotte, NC (US)

(72) Inventors: Joseph Benjamin Castinado, North Glenn, CO (US); Bryan Lee Card, Thousand Oaks, CA (US); Robert William Powers, Charlotte, NC (US); Richard Huw Thomas, Charlotte, NC (US)

(73) Assignee: BANK OF AMERICA CORPORATION, Charlotte, NC (US)

(21) Appl. No.: 16/212,937

(22) Filed: Dec. 7, 2018

(51) Int. Cl. G06Q 20/10; G06F 21/31; G06Q 40/02; H04L 29/06

(52) U.S. Cl. CPC G06Q 20/1085; H04L 63/08; G06Q 40/02; G06F 21/31

(57) ABSTRACT

Embodiments of the invention are directed to a system, method, or computer program product for an interconnected resource distribution and retention network. The invention is structured for centralized or de-centralized network processing. In this way, the invention creates a network of interconnected agnostic resource distribution machines as nodes across a distributed network allowing resource distribution to customers across various entities. The system stores entity specific resource distribution machine interactive software. Upon user authentication into a resource distribution machine associated with the network, the system presents the user's entity specific resource distribution machine interactive software for user visualization and resource distribution completion.

### BACKGROUND

Conventional resource distribution machines are proprietary and thus resource denominations, security, software, hardware, and the like are maintained by an entity. This also limits user availability to resource distribution technology. As such, there exists a need for an interconnected resource distribution machine network.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In some embodiments, the invention provides an interconnected resource distribution and retention network that provides entities the ability to become a node/participant in a decentralized network of resource distribution machines, such as automated teller machines (ATM).

Any entity with distributions to users occurring over a resource distribution machine can register and participate in the network. In some embodiments, once the entity is registered as a node on the distributed network any of that entity's customers may have access to and use the shared resource distribution machines. The machines, while shared across multiple entities, may provide a user interface, upon user authentication, that is displayed visually similar to the display and appearance associated with the entity the user holds one or more accounts with. In this way, the user may have an experience as if the ATM was his/her financial institution ATM display. In this way, the system generates a network of resource distribution machines, rather than the necessity of each entity owning and maintaining their own resource distribution machines. This significantly reduces expenses, hardware updating, software updating, and provides an all access platform through display manipulation for each customer of each entity. In this way, there is one universal resource distribution machine that any of the entities can use. Once the entity customer authenticates at the resource distribution machine, the machine determines if the entity associated with the customer is part of the network and then presents the customer with the specific entity's normal capabilities and interactions. The network performs two major actions, first it ensure the use's entity is part of the shared network and second, it provides the user with the visualization and functionality that is similar to a single entity owned resource distribution machine.

Embodiments of the present invention address these and/or other needs by providing an innovative system, method and computer program product for interconnected resource distribution and retention, the invention comprising: generating a network of resource distribution machines, wherein each resource distribution machine comprises a node on the network; interlinking and linking the resource distribution machines across the network; storing entity specific user interface display data centrally for deployment at the resource distribution machines; identifying a user accessing and authenticating at a resource distribution machine within the network of the resource distribution machines; based on the authentication, identifying an entity associated with an account the user is accessing and authenticating to gain access to via the resource distribution machine; and displaying entity specific user interface via a display associated with the resource distribution machine, wherein the entity specific user interface includes a visual display same as the display of an entity resource distribution display of the entity associated with the account the user is accessing.

In some embodiments, the network comprises a decentralized network wherein the resource distribution machines are owned and maintained by multiple entities in a shared peer-to-peer network. In some embodiments, the network comprises a centralized network wherein the resource distribution machines are centrally owned and maintained and connect via back end interconnect within a debit network to financial institutions.

In some embodiments, the network is associated with a distributed network for storing transactions across the network of resource distribution machines via a block chain distributed network.

In some embodiments, the resource distribution machines are scrubbed of entity specific data and software upon being localized onto the network.

In some embodiments, entity specific user interface display data comprises software that illustrates user display data on the resource distribution machine.

In some embodiments, the resource distribution machines across the network are maintained by one or more entities, wherein the entities are financial institutions. In some embodiments, the resource distribution machines comprise automated teller machines.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an interconnected resource distribution and retention network system environment, in accordance with one embodiment of the present invention;

FIG. 2 provides an ATM system environment, in accordance with one embodiment of the present invention;

FIG. 3 provides a resource distribution machine interface, in accordance with one embodiment of the present invention;

FIG. 4A provides a process flow illustrating a centralized database, in accordance with one embodiment of the present invention;

FIG. 4B provides a process flow illustrating a decentralized database network, in accordance with one embodiment of the present invention;

FIG. 5 provides a process flow illustrating resource distribution nodes across the decentralized interconnected resource distribution and retention network, in accordance with one embodiment of the present invention;

FIG. 6 provides a process map illustrating initiation of the decentralized or centralized network, in accordance with one embodiment of the present invention; and

FIG. 7 provides a process map illustrating processing an interaction via the interconnected resource distribution and retention network, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any customer of an entity or individual that interacts with an entity. The user may interact with a financial institution as a customer. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “transaction” or “resource distribution” refers to any communication between a user and the financial institution or other entity to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, the point-of-transaction device (POT) may be or include a merchant machine and/or server and/or may be or include the mobile device of the user may function as a point of transaction device. The embodiments described herein may refer to the use of a transaction, transaction event or point of transaction event to trigger the steps, functions, routines or the like described herein. In various embodiments, occurrence of a transaction triggers the sending of information such as alerts and the like. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like).

In some embodiments, information associated with the purchase transaction is received from a POT including a point-of-sale (POS) terminal during a transaction involving a consumer and a merchant. For example, a consumer checking out at a retail merchant, such as a grocer, may provide to the grocer the one or more goods or products that he is purchasing together with a payment method, loyalty card, and possibly personal information, such as the name of the consumer. This information along with information about the merchant may be aggregated or collected at the POS terminal and routed to the system or server of the present invention or otherwise a third party affiliate of an entity managing the system of this invention. In other embodiments when the purchase transaction occurs over the Internet, the information associated with the purchase transaction is collected at a server providing an interface for conducting the Internet transaction. In such an embodiment, the consumer enters product, payment, and possibly personal information, such as a shipping address, into the online interface, which is then collected by the server. The server may then aggregate the transaction information together with merchant information and route the transaction and merchant information to the system of the present invention. It will be further be understood that the information associated with the purchase transaction may be received from any channel such as an ATM, Internet, peer-to-peer network, POS, and/or the like.

“Block chain” as used herein refers to a decentralized electronic ledger of data records which are authenticated by a federated consensus protocol. Multiple computer systems within the block chain, referred to herein as “nodes” or “compute nodes,” each comprise a copy of the entire ledger of records. Nodes may write a data “block” to the block chain, the block comprising data regarding a transaction. In some embodiments, only miner nodes may write transactions to the block chain. In other embodiments, all nodes have the ability to write to the block chain. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the block chain will persist so long as the nodes on the block chain persist. A “private block chain” is a block chain in which only authorized nodes may access the block chain. In some embodiments, nodes must be authorized to write to the block chain. In some embodiments, nodes must also be authorized to read from the block chain. Once a transactional record is written to the block chain, it will be considered pending and awaiting authentication by the miner nodes in the block chain.

“Miner node” as used herein refers to a networked computer system that authenticates and verifies the integrity of pending transactions on the block chain. The miner node ensures that the sum of the outputs of the transaction within the block matches the sum of the inputs. In some embodiments, a pending transaction may require validation by a threshold number of miner nodes. Once the threshold number of miners has validated the transaction, the block becomes an authenticated part of the block chain. By using this method of validating transactions via a federated consensus mechanism, duplicate or erroneous transactions are prevented from becoming part of the accepted block chain, thus reducing the risk of data record tampering and increasing the security of the transactions within the system.

A “block” as used herein may refer to one or more records of a file with each record comprising data for transmission to a server. In some embodiments, the term record may be used interchangeably with the term block to refer to one or more transactions or data within a file being transmitted.

In some embodiments, the invention provides an interconnected resource distribution and retention network that provides entities the ability to become a node/participant in a decentralized network of resource distribution machines, such as automated teller machines (ATM). Any entity with distributions to users occurring over a resource distribution machine can register and participate in the network. In some embodiments, once the entity is registered as a node on the distributed network any of that entity's customers may have access to and use the shared resource distribution machines. The machines, while shared across multiple entities, may provide a user interface, upon user authentication, that is displayed visually similar to the display and appearance associated with the entity the user holds one or more accounts with. In this way, the user may have an experience as if the ATM was his/her financial institution ATM display. In this way, the system generates a network of resource distribution machines, rather than the necessity of each entity owning and maintaining their own resource distribution machines. This significantly reduces expenses, hardware updating, software updating, and provides an all access platform through display manipulation for each customer of each entity. In this way, there is one universal resource distribution machine that any of the entities can use. Once the entity customer authenticates at the resource distribution machine, the machine determines if the entity associated with the customer is part of the network and then presents the customer with the specific entity's normal capabilities and interactions. The network performs two major actions, first it ensure the use's entity is part of the shared network and second, it provides the user with the visualization and functionality that is similar to a single entity owned resource distribution machine.

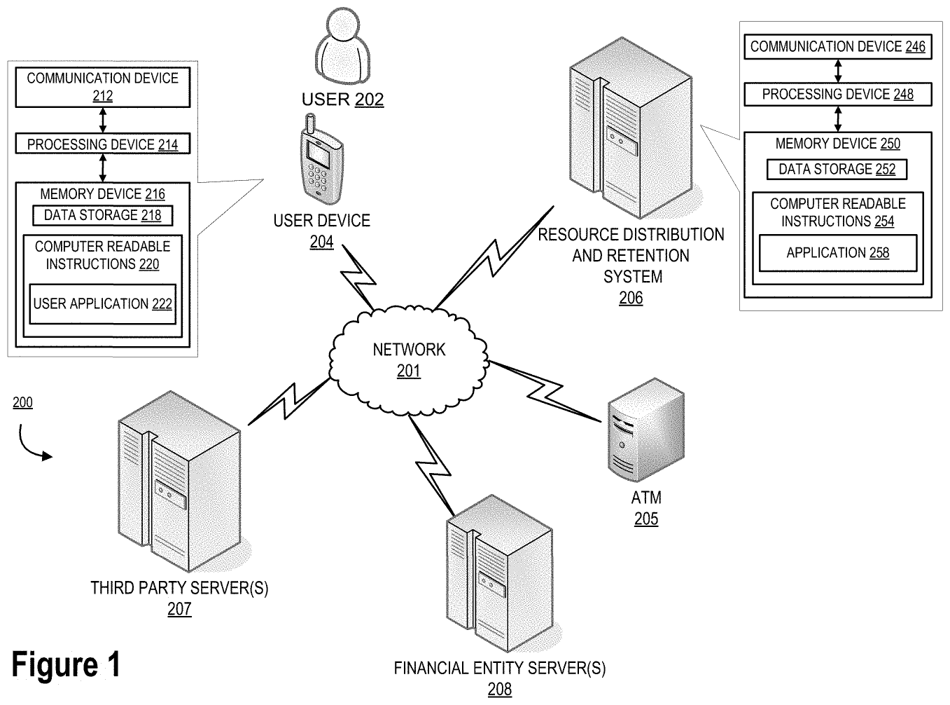

FIG. 1 provides an interconnected resource distribution and retention network system environment 200, in accordance with one embodiment of the present invention. FIG. 1 provides the system environment 200 for which the distributive network system with specialized data feeds associated with an interconnected resource distribution and retention network. In some embodiments, the network may be centralized. In some embodiments, the network may be decentralized. FIG. 1 provides a unique system that includes specialized servers and system communicably linked across a distributive network of nodes required to perform the functions described herein.

As illustrated in FIG. 1, the financial entity server 208 is operatively coupled, via a network 201 to the user device 204, ATM 205, third party servers 207, and to the resource distribution and retention system 206. In this way, the financial entity server 208 can send information to and receive information from the user device 204, ATM 205, third party servers 207, and the resource distribution and retention system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity that has one or more user devices 204 and is a customer of a financial institution exchanging or distributing resources that is associated with the network. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the resource distribution and retention system 206, the financial entity server 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the resource distribution and retention system 206.

As further illustrated in FIG. 1, the resource distribution and retention system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the financial entity server 208, the third party server 207, the ATM 205, and the user device 204. As such, the communication device 246 generally comprises a modem, server, or other device for communicating with other devices on the network 201.

As further illustrated in FIG. 1, the resource distribution and retention system 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the resource distribution and retention system 206 the memory device 250 stores an application 258. In one embodiment of the invention, the application 258 may associate with applications having computer-executable program code. Furthermore, the resource distribution and retention system 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more financial entity server 208, third party servers 207, ATM 205, and/or user device 204.

As illustrated in FIG. 1, the third party server 207 is connected to the financial entity server 208, user device 204, ATM 205, and resource distribution and retention system 206. The third party server 207 has the same or similar components as described above with respect to the user device 204 and the resource distribution and retention system 206. While only one third party server 207 is illustrated in FIG. 1, it is understood that multiple third party servers 207 may make up the system environment 200. The third party server 207 may be associated with one or more financial institutions, entities, or the like.

As illustrated in FIG. 1, the ATM 205 is connected to the financial entity server 208, user device 204, third party server 207, and resource distribution and retention system 206. The ATM 205 has the same or similar components as described above with respect to the user device 204 and the resource distribution and retention system 206. While only one ATM 205 is illustrated in FIG. 1, it is understood that multiple ATM 205 may make up the system environment 200.

As illustrated in FIG. 1, the financial entity server 208 is connected to the third party server 207, user device 204, ATM 205, and resource distribution and retention system 206. The financial entity server 208 may be associated with the resource distribution and retention system 206. The financial entity server 208 has the same or similar components as described above with respect to the user device 204 and the resource distribution and retention system 206. While only one financial entity server 208 is illustrated in FIG. 1, it is understood that multiple financial entity server 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The financial entity server 208 may generally include a processing device communicably coupled to devices as a memory device, output devices, input devices, a network interface, a power source, one or more chips, and the like. The financial entity server 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the financial entity server 208 described herein.

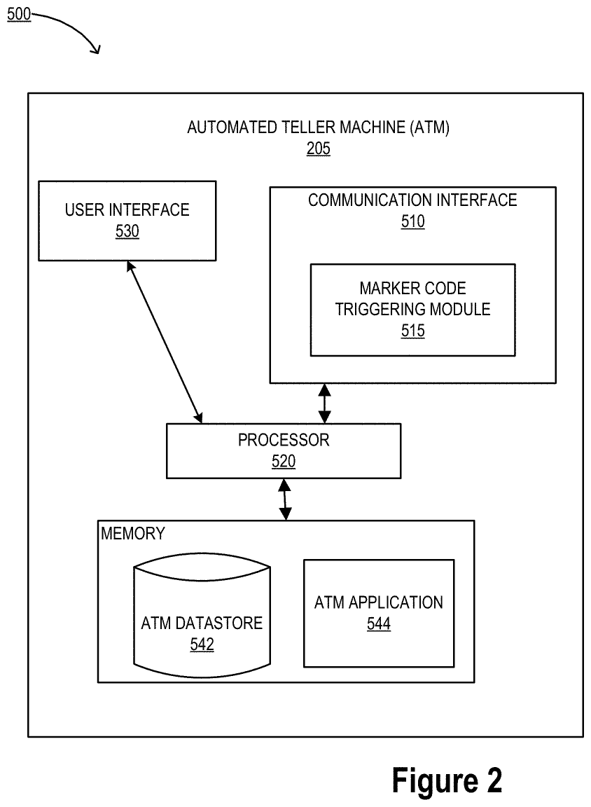

FIG. 2 illustrates an ATM system environment 500, in accordance with embodiments of the present invention. As illustrated in FIG. 2, the ATM 205 includes a communication interface 510, a processor 520, a user interface 530, and a memory 540 having an ATM datastore 542 and an ATM application 544 stored therein. As shown, the processor 520 is operatively connected to the communication interface 510, the user interface 530, and the memory 540.

The communication interface 510 of the ATM may include a marker code triggering module 515. The marker code triggering module 515 is configured to authorize a user via contact, contactless, and/or wireless information communication regarding the pin code or marker code inputted by the user. The marker code triggering module 515 may include a transmitter, receiver, smart card, key card, proximity card, radio frequency identification (RFID) tag and/or reader, and/or the like. In some embodiments, the marker code triggering module 515 communicates information via radio, IR, and/or optical transmissions. Generally, the marker code triggering module 515 is configured to operate as a transmitter and/or as a receiver. The marker code triggering module 515 functions to enable transactions with users using the ATM via identification of the user via physical authentication, contactless authorization, or the like. Also, it will be understood that the marker code triggering module 515 may be embedded, built, carried, and/or otherwise supported in and/or on the ATM 205. In some embodiments, the marker code triggering module 515 is not supported in and/or on the ATM 205, but the marker code triggering module 515 is otherwise operatively connected to the ATM 205 (e.g., where the marker code triggering module 515 is a peripheral device plugged into the ATM 205 or the like).

The communication interface 510 may generally also include a modem, server, transceiver, and/or other device for communicating with other devices and systems on a network.

The user interface 530 of the ATM 205 may include a display (e.g., a liquid crystal display, a touchscreen display, and/or the like) which is operatively coupled to the processor 520. The user interface 530 may include any number of other devices allowing the ATM 205 to transmit/receive data to/from a user, such as a keypad, keyboard, touch-screen, touchpad, microphone, mouse, joystick, other pointer device, button, soft key, and/or other input device(s).

As further illustrated in FIG. 2, the memory 540 may include ATM applications 544. It will be understood that the ATM applications 544 can be executable to initiate, perform, complete, and/or facilitate one or more portions of any embodiment described and/or contemplated herein. Generally, the ATM application 544 is executable to receive transaction instructions from the user and perform typical ATM functions, as appreciated by those skilled in the art. In some embodiments of the invention, the ATM application is configured to access content, such as data stored in memory, for example in the ATM datastore 542, or a database in communication with the ATM 205 and may transfer the content to the external apparatus if the external apparatus is configured for ATM communication.

Of course, the ATM 205 may require users to identify and/or authenticate themselves to the ATM 205 before the ATM 205 will initiate, perform, complete, and/or facilitate a transaction. For example, in some embodiments, the ATM 205 is configured (and/or the ATM application 544 is executable) to authenticate an ATM user based at least partially on an ATM debit card, smart card, token (e.g., USB token, or the like), username, password, pin, biometric information, and/or one or more other credentials that the user presents to the ATM 205. Additionally or alternatively, in some embodiments, the ATM 205 is configured to authenticate a user by using one-, two-, or multi-factor authentication. For example, in some embodiments, the ATM 205 requires two-factor authentication, such that the user must provide a valid debit card and enter the correct pin associated with the debit card in order to authenticate the user to the ATM 205. However, in some embodiments, the user may access the ATM 205 and view or receive content that may be transferred to/from the ATM 205.

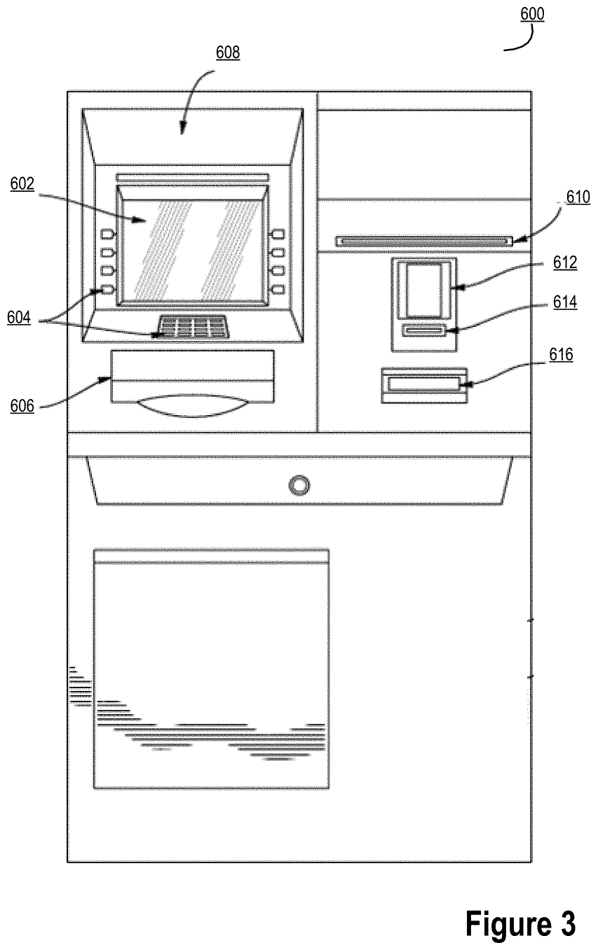

FIG. 3 provides a resource distribution machine interface 600, in accordance with one embodiment of the present invention. While an ATM is presented in FIG. 3, the device may be any resource distribution machine interface such as an ATM, transaction device, kiosk, terminal, merchant location, online interface, financial institution interface, or the like. FIG. 3 provides a representative illustration of an ATM, in accordance with one embodiment of the present invention. In some embodiments, the representative ATM may comprise features similar to features found on a standard ATM. The lighting means 608 may be located above the display 602 that may provide a customer light for use during an ATM transaction. Of note, the display 602 may be vertically adjusted or horizontally adjusted along tracks or the like to position itself across the entire ATM. While currently illustrated in the upper left corner of the ATM, one will appreciate that the display may move to the right upper corner or below to the lower corners of the ATM and/or anywhere in between if necessary. The lighting means 608 may also be moved with the ATM display 602 and provide the customer a safety mechanism to aid in the ATM transaction.

The cash receptacle 606 may provide the customer means for receiving cash that the customer requests for withdraw through the ATM transaction. In some embodiments, the ATM may also include a contactless identification sensor 612, a contact identification sensor 614 such as a debit or ATM card acceptor, a keypad 604, a receipt receptacle 610, and a deposit receptacle 616. In some embodiments, the contactless identifier 612 and/or the contact identifier 614 may provide the ATM means of receiving identification from the customer. The customer may provide contactless or contact identification means through the ATM. The identification means using a contactless or contact identifications may be provided through several mechanisms, including, but not limited to, biometric identification, laser identification, magnetic strip identification, barcode identification, radio frequency (RF), a character recognition device, a magnetic ink, code readers, wireless communication, debit card scanning, ATM card scanning, and/or the like. The authentication from the contactless identifier of contact identifier may be read by the ATM application. After the authentication has been read, the system may provide the authentication to the financial institution to authorize an ATM transaction.

In some embodiments, the keypad 604 may provide for identification of the customer for use of the ATM. The keypad 604 may provide the customer means for inputting a pin number identification. In this way, the keypad 604 enables the customer to input his pin number into the ATM. In some embodiments, the pin number inputted on the keypad 604 may be read by the system. After the pin number has been read, the ATM may receive the pin number and provide authentication of the identification with the financial institution system.

The display 602 provides a means for displaying information related to the customer's ATM transaction. Display information may be, but is not limited to display of interfaces, such as the start-up interface and an ATM transaction interface. In some embodiments, the display 602 is a touch screen display module.

It is understood that the servers, systems, and devices described herein illustrate one embodiment of the invention. It is further understood that one or more of the servers, systems, and devices can be combined in other embodiments and still function in the same or similar way as the embodiments described herein.

In some embodiments, the network is a centralized network operated by a single entity. In other embodiments, the network is a decentralized network operating between one or more entities. Any entity with resource distribution machines, such as ATMs can register and participate in the network to distribute resources to a user via the network. In some embodiments, once the entity is registered as a node on the network any of that entity's customers may have access to and use the shared resource distribution machines. The machines, while shared across multiple entities, may provide a user interface, upon user authentication, that is displayed visually similar to the display and appearance associated with the entity the user holds one or more accounts with. In this way, the user may have an experience as if the ATM was his/her financial institution ATM display. In this way, the system generates a network of resource distribution machines, rather than the necessity of each entity owning and maintaining their own resource distribution machines. This significantly reduces expenses, hardware updating, software updating, and provides an all access platform through display manipulation for each customer of each entity. In this way, there is one universal resource distribution machine that any of the entities can use. Once the entity customer authenticates at the resource distribution machine, the machine determines if the entity associated with the customer is part of the network and then presents the customer with the specific entity's normal capabilities and interactions. The network performs two major actions, first it ensure the use's entity is part of the shared network and second, it provides the user with the visualization and functionality that is similar to a single entity owned resource distribution machine.

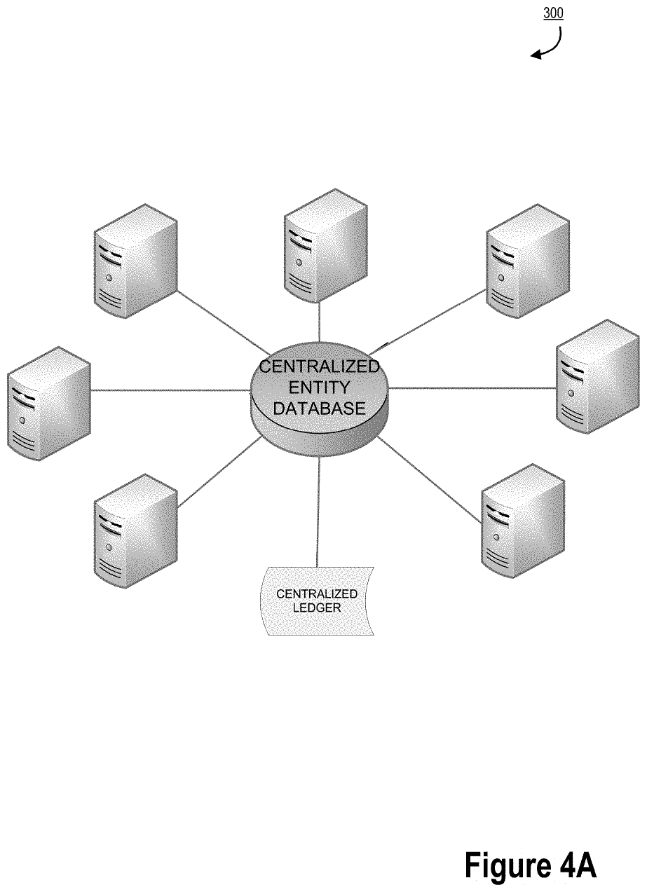

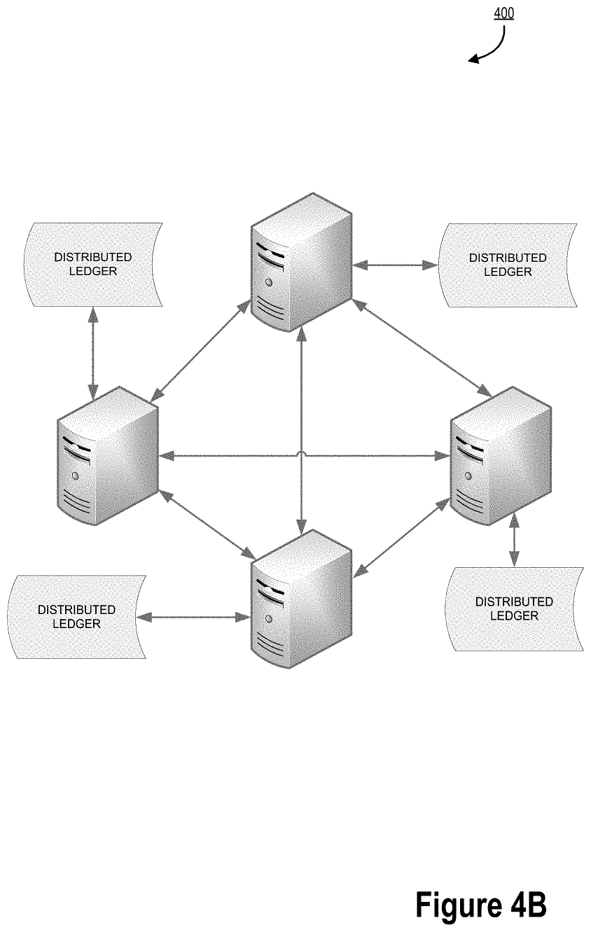

FIG. 4A provides a process flow illustrating a centralized database 300, in accordance with one embodiment of the present invention. In this way, in some embodiments, the interconnected resource distribution and retention network may be a centralized entity network. The centralized database architecture comprises multiple nodes from one or more sources and converge into a centralized database. The system, in this embodiment, may generate a single centralized ledger for data received from the various nodes. The single centralized ledger for data provides an avenue for reviewing resource transfers from the one or more nodes as resources are being transferred across various ATMs.

Using this centralized system, when resource transactions are preformed, the centralized database may identify those transactions and process them through a centralized ledger system. In this way, one entity may be able to process various account resource distributions across multiple financial institutions.

FIG. 4B provides a process flow illustrating a decentralized database network 400, in accordance with one embodiment of the present invention. In this way, in some embodiments, the interconnected resource distribution and retention network may be decentralized. In some embodiments, the invention may use a decentralized block chain configuration or architecture as shown in FIG. 4B in order to facilitate resource distributions at an ATM. Such a decentralized configuration allows for mapping and tagging of ATM transactions during or after the transmission. Accordingly, a block chain configuration may be used to maintain an accurate ledger of files and the processing of transmission of the resource distributions occurring at the various decentralized ATMs by generation of a hash building of one or more blocks for each transaction. In this way, building a traceable and trackable historic view of each transaction for identification.

In some embodiments, either the decentralized network of the centralized network may utilize a block chain network for transaction processing. A block chain is a distributed database that maintains a list of data blocks, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes may be maintained by different entities.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In some embodiments, the block chain system is closed, as such the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

A block chain system is typically decentralized—meaning that a distributed ledger 402 (i.e., a decentralized ledger) is maintained on multiple nodes of the block chain. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains. In some embodiments, the nodes 408 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications.

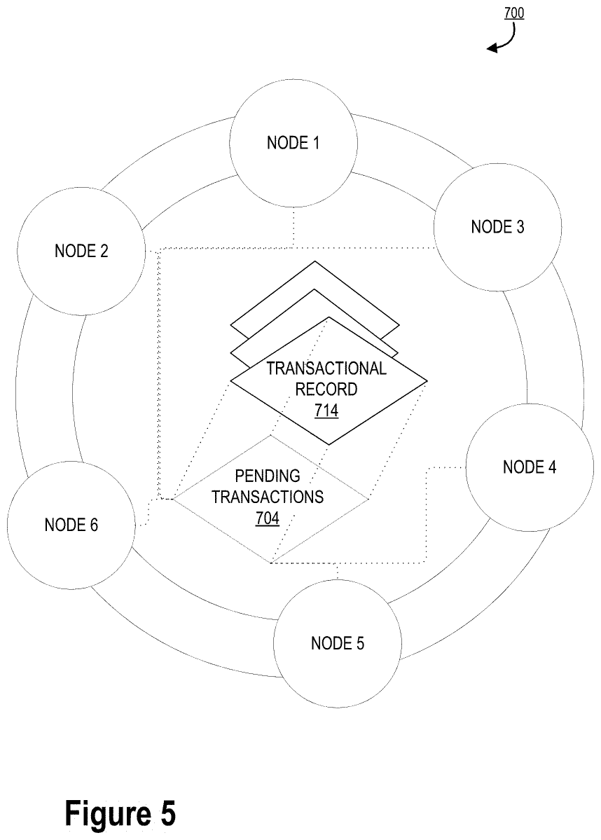

FIG. 5 provides a process flow illustrating resource distribution nodes across the decentralized interconnected resource distribution and retention network 700, in accordance with one embodiment of the present invention. As illustrated, multiple nodes exist across the network. These include Node 1, Node 2, Node 3, Node 4, Node 5, and Node 6. In some embodiments, these nodes may be individual ATMs. In other embodiments, each node may be a financial institution or entity that has multiple ATMs across its node. In this way, each node may be a single ATM or a network of ATMs. Each ATM at each node is linked to a pending transaction record, as illustrated in block 704. The transactions are then stored within a transactional record as illustrated in block 714.

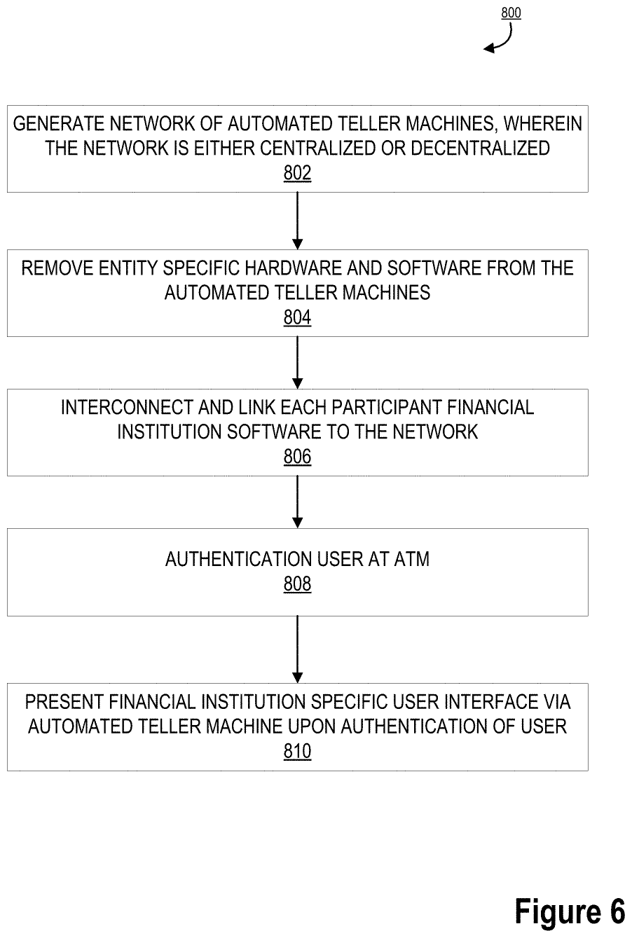

FIG. 6 provides a process map illustrating initiation of the decentralized or centralized network 800, in accordance with one embodiment of the present invention. As illustrated in block 802, the process 800 is initiated by generating a network of ATMs. In this way, the system may link one or more ATMs together into a single network. In some embodiments, the network may be a centralized network, where all of the ATMs are controlled, owned, or operated by a centralized entity. In some embodiments, the network may be a decentralized network, where the ATMs are all owned by one or more entities and access to the ATMs is allowed across the decentralized network to each party of the network.

As illustrated in block 804, the process 800 continues by removing the entity specific hardware and software from the ATM machines across the network. In this way, the system scrubs the ATM of any entity specific hardware, software, branding, or the like for integration across the network.

Next, as illustrated in block 806 the process 800 continues by interconnecting and linking each participant financial institution software to the network. In this way, the system may compile the software used by each financial institution within their respective ATMs. The system may interconnect the various software formats for streamline integration into the network of resource distribution machines. As such, system specific hardware and software may be loaded onto each ATM across the network. The network may also maintain financial institution specific software that is scrubbed to illustrate visualization of the interfaces of the financial institution software at an ATM. In this way, the financial institution specific software is scrubbed to only include visual aspects of user interfaces, interaction tabs, and the like associated with a resource distribution machine.

As illustrated in block 806, a user may be identified at an ATM associated with the network and be authenticated at the ATM. In this way, the user may request access to his/her account at an ATM via an authentication process. Via that authentication process, the system may identify the financial institution associated with the user, such as via card/PIN, mobile device communication, or the like. At that point, the system may identify the financial institution and extract the financial institution software associated with the user's financial institution. As illustrated in block 810, the system identifies the user and the financial institution associated with the user and presents the financial institution specific user interface to the user via the ATM display upon authentication of the user. As such, even though the ATM is in a network of ATMs, the system may present specific financial institution user interfaces to the users associated with that financial institution.

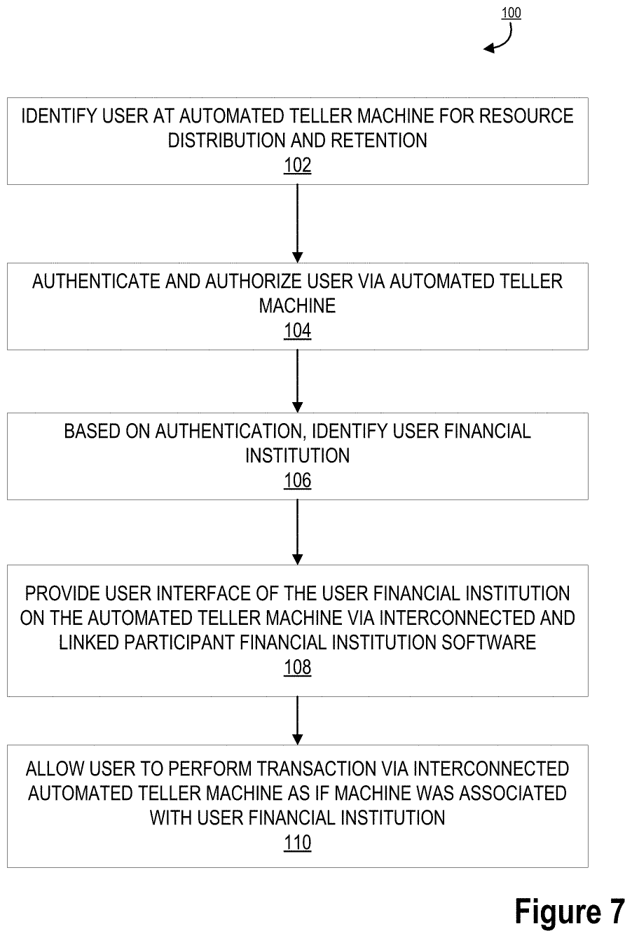

FIG. 7 provides a process map illustrating processing an interaction via the interconnected resource distribution and retention network 100, in accordance with one embodiment of the present invention. As illustrated in block 102, the process 100 is initiated by identifying the user at an ATM for resource distribution and retention. In this way, the user may have approached an ATM within the network of ATMs in order to perform a transaction at the ATM. Next, as illustrated in block 104, the process 100 continues by authenticating and authorizing the user at the ATM. This may be done via debit card/PIN, near field communication, mobile device recognition, password input, biometric scanning, or the like.

Upon authentication of the user at the ATM within the interconnected network of ATMs, the system based on that authentication, may identify the user financial institution, as illustrated in block 106. The system may identify the financial institution associated with the network that the user has an account with and that the user is attempted to access via the ATM.

The system may extract the financial institution specific software for the user interface based on the identification of the user's financial institution and provide the user interface of the user financial institution on the ATM via the interconnected and linked participant financial institution software stored within the network, as illustrated in block 108. In this way, the system identifies and matches the user with the appropriate financial institution software to provide the user with the look and feel of the ATM being associated with his/her financial institution.

Next, as illustrated in block 110, the process 100 is completed by allowing the user to perform transactions via the interconnected ATM as if the machine was associated with the user financial institution, such that the user interface, buttons, applications, and the like are the same as the user financial institution ATM.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for interconnected resource distribution and retention, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
generate a network of resource distribution machines, wherein each resource distribution machine comprises a node on the network;
interlink the resource distribution machines across the network;
store entity specific user interface display data centrally for deployment at the resource distribution machines;
identify a user accessing and authenticating at a resource distribution machine within the network of the resource distribution machines;
based on the authentication, identify an entity associated with an account the user is accessing and authenticating to gain access to via the resource distribution machine; and
display entity specific user interface via a display associated with the resource distribution machine, wherein the entity specific user interface includes a visual display same as the display of an entity resource distribution display of the entity associated with the account the user is accessing.

2. The system of claim 1, wherein the network comprises a decentralized network wherein the resource distribution machines are owned and maintained by multiple entities in a shared peer-to-peer network.

3. The system of claim 1, wherein the network comprises a centralized network wherein the resource distribution machines are centrally owned and maintained and connect via back end interconnect within a debit network to financial institutions.

4. The system of claim 1, wherein the network is associated with a distributed network for storing transactions across the network of resource distribution machines via a block chain distributed network.

5. The system of claim 1, wherein the resource distribution machines are scrubbed of entity specific data and software upon being localized onto the network.

6. The system of claim 1, wherein entity specific user interface display data comprises software that illustrates user display data on the resource distribution machine.

7. The system of claim 1, wherein the resource distribution machines across the network are maintained by one or more entities, wherein the entities are financial institutions.

8. The system of claim 1, wherein the resource distribution machines comprise automated teller machines.

9. A computer program product for interconnected resource distribution and retention, the computer program product comprising at least one non-transitory computer-readable medium having computer-readable program code portions embodied therein, the computer-readable program code portions comprising:
an executable portion configured for generating a network of resource distribution machines, wherein each resource distribution machine comprises a node on the network;
an executable portion configured for interlinking the resource distribution machines across the network;
an executable portion configured for storing entity specific user interface display data centrally for deployment at the resource distribution machines;
an executable portion configured for identifying a user accessing and authenticating at a resource distribution machine within the network of the resource distribution machines;
an executable portion configured for identifying, based on the authentication, an entity associated with an account the user is accessing and authenticating to gain access to via the resource distribution machine; and
an executable portion configured for displaying entity specific user interface via a display associated with the resource distribution machine, wherein the entity specific user interface includes a visual display same as the display of an entity resource distribution display of the entity associated with the account the user is accessing.

10. The computer program product of claim 9, wherein the network comprises a decentralized network wherein the resource distribution machines are owned and maintained by multiple entities in a shared peer-to-peer network.

11. The computer program product of claim 9, wherein the network comprises a centralized network wherein the resource distribution machines are centrally owned and maintained and connect via back end interconnect within a debit network to financial institutions.

12. The computer program product of claim 9, wherein the network is associated with a distributed network for storing transactions across the network of resource distribution machines via a block chain distributed network.

13. The computer program product of claim 9, wherein the resource distribution machines are scrubbed of entity specific data and software upon being localized onto the network.

14. The computer program product of claim 9, wherein entity specific user interface display data comprises software that illustrates user display data on the resource distribution machine.

15. A computer-implemented method for interconnected resource distribution and retention, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
generating a network of resource distribution machines, wherein each resource distribution machine comprises a node on the network;
interlinking the resource distribution machines across the network;
storing entity specific user interface display data centrally for deployment at the resource distribution machines;
identifying a user accessing and authenticating at a resource distribution machine within the network of the resource distribution machines;
identifying, based on the authentication, an entity associated with an account the user is accessing and authenticating to gain access to via the resource distribution machine; and
displaying entity specific user interface via a display associated with the resource distribution machine, wherein the entity specific user interface includes a visual display same as the display of an entity resource distribution display of the entity associated with the account the user is accessing.

16. The computer-implemented method of claim 15, wherein the network comprises a decentralized network wherein the resource distribution machines are owned and maintained by multiple entities in a shared peer-to-peer network.

17. The computer-implemented method of claim 15, wherein the network comprises a centralized network wherein the resource distribution machines are centrally owned and maintained and connect via back end interconnect within a debit network to financial institutions.

18. The computer-implemented method of claim 15, wherein the network is associated with a distributed network for storing transactions across the network of resource distribution machines via a block chain distributed network.

19. The computer-implemented method of claim 15, wherein the resource distribution machines are scrubbed of entity specific data and software upon being localized onto the network.

20. The computer-implemented method of claim 15, wherein entity specific user interface display data comprises software that illustrates user display data on the resource distribution machine.
